(19) United States
(12) Patent Application Publication
(10) Pub. No.: US 2006/0100869 A1
(43) Pub. Date: May 11, 2006

(54) Pattern recognition accuracy with distortions

(75) Inventors: Trevor Thomas, Milton (GB); Beng Tiong Tan, Sawston (GB)

Correspondence Address: THE WEBB LAW FIRM, P.C., 700 KOPPERS BUILDING, 436 SEVENTH AVENUE, PITTSBURGH, PA, 15219, US

(73) Assignee: Fluency Voice Technology Ltd., London (GB)

(21) Appl. No.: 11/238,673

(22) Filed: Sep. 29, 2005

(30) Foreign Application Priority Data
Sep. 30, 2004 (GB) 0421775.8

(51) Int. Cl. G10L 15/06

(52) U.S. Cl. 704/243

(57) ABSTRACT

A pattern recogniser is arranged to receive an input signal and to generate a matching output pattern comprises a pattern matcher, a signal modification module and an output pattern combiner. The pattern matcher includes a signal processor and a pattern matching module. The signal modification module modifies the input signal before it reaches the pattern matching module, and the output pattern combiner is arranged to combine a plurality of output patterns matched by the pattern matching module with different modifications applied to the input signal.

### CROSS REFERENCE TO RELATED APPLICATIONS

This application corresponds to British Application No. 0421775.8 filed Sep. 30, 2004, which is herein incorporated by reference in its entirety.

### BACKGROUND OF THE INVENTION

This invention relates to pattern recognition, in particular to a speech recognition system.

A pattern recognition system, such as a speech recognition system, takes an input signal, processes it, and attempts to find a pattern represented by the input signal. For a speech recogniser, the input signal is a stream of speech, which is decoded by the recogniser into a string of words that represent the speech signal.

Pattern matchers generally have an architecture as given in FIG. 1. The input signal 1 is presented to a pattern matcher 2 which then attempts to hypothesise the correct output pattern 3 through the use of an internal algorithm.

Internally, the pattern matcher 2 will execute a two-stage operation to perform the hypothesis generation, as depicted in FIG. 2, which combines apparatus features with the steps carried out by the apparatus. First of all, a signal processor 4 carries out a signal processing step to convert the input signal 1 into a different signal that is suitable for the pattern matching algorithm step 5 in the pattern matcher 2 to use.

Typically, this step will split the input signal 1 into small portions of material and convert each portion into a vector of numbers. For speech recognition-pattern matchers 2, this vector is generated at regular intervals and it is this vector that is used by the following pattern matching algorithm step 5 as its input. For all pattern matchers, the accuracy of the output symbol string is dependent primarily on the quality of the signal processing operation.

Pattern matchers 2 generally try to locate the output pattern 3 that best matches the input signal 1. There are, however, many practical cases in which other output patterns are also of use. These patterns will not be the most likely output pattern, but will be the second most likely pattern, the third most likely pattern etc. These cases generally arise where there is other information available to the controlling application that has not come from the input signal 1 and this information can be used to select which of the multiple hypothesised output patterns best represent the input signal 1. FIG. 3 shows how this technique can be used. This kind of operation is called n-best recognition, where the n-best refers to the list of n output patterns that the pattern matcher 2 produces after processing the input signal 1. The combination of the method described above and the use of the n-best patterns can be used advantageously to deliver much higher accuracy from the pattern matcher 2 than would otherwise be possible. In particular, for a speech recognition system, the accuracy of the most likely hypothesis from the recogniser might be quite poor, too poor to be usable, however if the speech recogniser is instructed to compute the n-best sentence list, the hypothesis that actually matches the spoken utterance from the speaker is found to be in the n-best list much more frequently. Therefore the pattern matcher 2 further includes an n-best pattern calculator 6 which produces a list of the n best patterns that are most likely to be the correct match, taking account of the other information.

Such pattern recognition systems will sometimes make errors, and the invention described here attempts to reduce those errors.

### SUMMARY OF THE INVENTION

According to a first aspect of the present invention a pattern recogniser is arranged to receive an input signal and to generate a matching output pattern and comprises: a pattern matcher including a signal processor and a pattern matching module; a signal modification module which modifies the input signal before it reaches the pattern matching module; and an output pattern combiner arranged to combine a plurality of output patterns matched by the pattern matching module with different modifications applied to the input signal.

Taken by themselves, modifications to the signal don't always improve recognition or pattern matching. For example, with speech recognition, a long string of speech might be recognised most accurately without any modification, but there will be certain utterances within the speech which are poorly recognised without any modification, but which are well recognised after modification. Therefore, by pattern matching an input signal both without modification and with modification, and generating an n best result from both pattern matchers, the correct match for every utterance is likely to be available for picking. In practice, each utterance is likely to be passed through several pattern matching algorithms having had different modifications applied to them, thereby increasing the likelihood of the best match being made available for picking.

The modifications can be linear, non-linear, include noise, be expansion functions, compression functions, or be scaling functions. The use of n-best results is also advantageous.

Further advantageous features are defined in the claims.

### BRIEF DESCRIPTION OF THE DRAWINGS

Embodiments of the present invention will now be described by way of example only, with reference to the drawings in which:

FIG. 1 is a diagram showing, in schematic form, a known pattern recognition system in which an input signal is pattern matched by a pattern matcher to generate an output pattern that matches the input signal;

FIG. 2 is a diagram showing another known pattern recognition system;

FIG. 3 is a diagram showing a third known pattern recognition system which includes an n-best pattern calculator;

FIG. 4 is a diagram showing, in schematic form, a first embodiment of the present invention including external signal modification;

FIG. 5 is a diagram showing a second embodiment of the present invention including internal modification;

FIG. 6 is a diagram showing a third embodiment of the invention including external modification;

FIG. 7 is a diagram showing a fourth embodiment of the invention including internal modification;

FIG. 8 is a diagram showing a fifth embodiment of the invention including external modification and three parallel pattern matchers;

FIG. 9 is a graph showing the recognition accuracy for the speech recogniser shown in FIG. 8, with and without external modification;

FIG. 10 is a diagram showing a sixth embodiment of the invention including internal modification and three parallel pattern matchers;

FIG. 11 is a graph showing the recognition accuracy for the speech recogniser shown in FIG. 10, with and without internal modification.

FIG. 12 is a block diagram of a computer system forming an embodiment of the present invention, and illustrating the connections thereinto, as well as the computer program and data stored thereby.

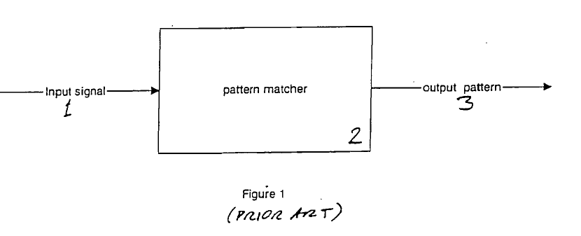

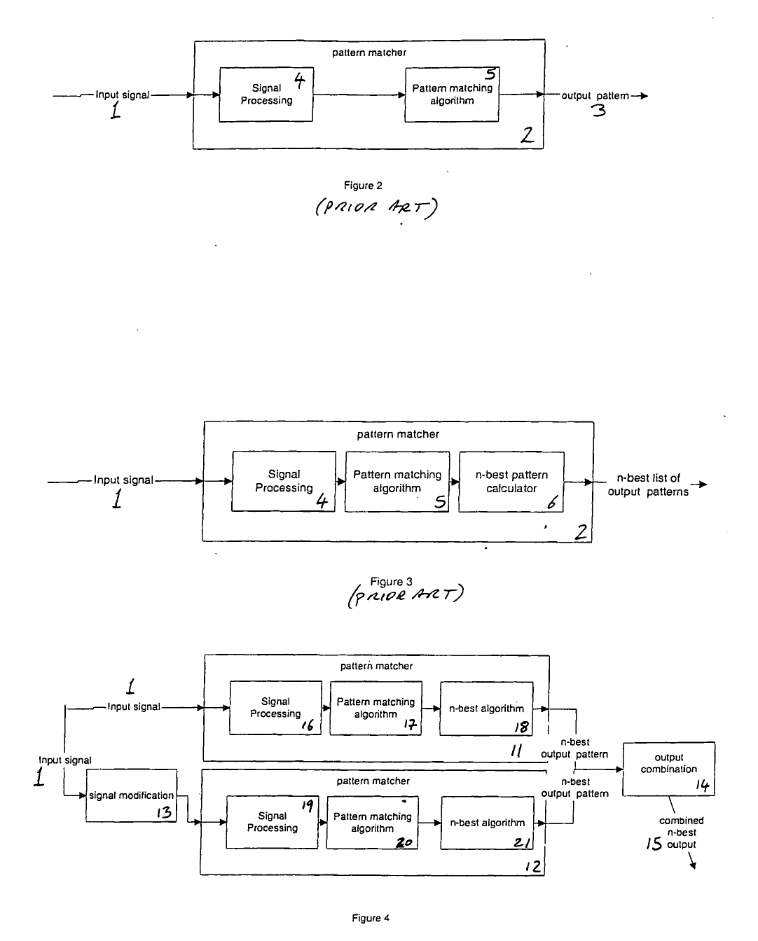

### DESCRIPTION OF THE PREFERRED EMBODIMENTS

The invention will now be described with reference to FIGS. 4 to 12.

FIG. 12 is a block diagram illustrating a computer system which may embody the present invention, and the context in which the computer system may be operated. More particularly, a computer system 1300 which may be conventional in its construction in that it is provided with a central processing unit, memory, long term storage devices such as hard disk drives, CD ROMs, CD-R, CD-RW, DVD ROMs or DVD RAMs, or the like, as well as input and output devices such as keyboards, screens, or other pointing devices, is provided. The computer system 1300 is, as mentioned, provided with a data storage medium 1302, such as a hard disk drive, floppy disk drive, CD ROM, CD-R, CD-RW, DVD ROM or RAM, or the like upon which is stored computer programs arranged to control the operation of the computer system 1300 when executed, as well as other working data. In particular, operating system program 1308 is provided stored on the storage medium 1302, and which performs the usual operating system functions to enable the computer system 1300 to operate. Additionally provided is an application program 1310, which is a user application program to enable a user of the computer system 1300 to perform tasks enabled by the application program. For example, the application program 1310 might be a word processing application such as Microsoft Word, Lotus Wordpro, or the like, or it may be any other application, such as a web browser application, a database application, a spreadsheet application, etc. Additionally provided in accordance with embodiments of the invention is a speech recogniser program 1304 which when executed by the computer system 1300 operates to recognise any input audio signals input thereto as speech, and to output a recognition signal, usually in the form of text, indicative of the recognised speech.

According to the invention, pattern recognition can be improved by modifying the input signal either before an existing recogniser is presented with the material to be recognised, or within the recogniser's internal operation. In the variant of the invention that is used to process the material before the material is presented to the recogniser, the material is deliberately distorted in a manner that proves to be advantageous to the ability of the subsequent recogniser to provide more accurate results. In the variant of the invention that is used within the recogniser's internal operation, the internal representation of the signal can be distorted to produce more accurate results from the recogniser.

In particular, for the specific case of speech recognition pattern matchers, modification can be used multiple times, each using a variety of distortions to produce a number of different results from the recogniser. These results can then be used in a similar manner to n-best result sentence lists to further enhance the speech recognition accuracy in circumstances where the use of multiple results form the recogniser is useful.

A first embodiment of the present invention is shown in FIG. 4 in which a pattern recognition system receives an input signal 1, and includes a first pattern matcher 11, a second pattern matcher 12, a signal modifier 13 and an output combination 14 which generates a combined n-best output 15 which best matches the input signal. The input signal is applied to the first pattern matcher 11 and to the signal modifier 13. The modified signal from the signal modifier is passed to the second pattern matcher 12. Each of the pattern matchers 11, 12 includes a signal processor 16, 19, a pattern matching algorithm 17, 20 and an n-best pattern algorithm 18, 21. Each pattern matcher 11, 12 generates n-best output patterns which are fed into the output combination 14. The figures show the system as part of a flow of steps, and so it will be understood that the features of the system that are shown are also indicative of the steps carried out within the system. This applies to all of the Figures which show, not just to that shown in FIG. 4.

The output of the first or unmodified pattern matcher 11 combined with the output of the second pattern matcher 12 can be demonstrated to deliver superior performance over the unmodified pattern matcher alone. In this case, the signal modification is performed externally before the presentation of the input signal to the pattern matcher. The output combination module 14 receives as its input the output of both of the pattern matchers and combines them into a single output 15. More than one pattern matcher is required as each one processes a particular processed signal. The combination function just combines the output from all pattern matchers into a single output, removing duplicates as it progresses.

At this point, it should be understood that taken by themselves, modifying the signal doesn't always improve recognition or pattern matching. For example, with speech recognition, a long string of speech might be recognised most accurately without any modification, but there will be certain utterances within the speech which are poorly recognised without any modification, but which are well recognised after modification. Therefore, by pattern matching an input signal both without modification and with modification, and generating an n best result from both pattern matchers, the correct match for every utterance is likely to be available for picking. In practice, each utterance is likely to be passed through several pattern matching algorithms having had different modifications applied to them, thereby increasing the likelihood of the best match being made available for picking.

A second embodiment of the present invention is shown in FIG. 5 in which a pattern recognition system receives an input signal 1, and includes a first pattern matcher 11, a second pattern matcher 12, and an output combination 14 which generates a combined n-best output 15 which best matches the input signal. The input signal is applied to the first and second pattern matchers 11, 12. Each of the pattern matchers 11, 12 includes a signal processor 16, 19, a pattern matching algorithm 17, 20 and an n-best pattern algorithm 18, 21. The second pattern matcher 12 includes a signal modifier 13 immediately before the pattern matching algorithm 20. Each pattern matcher 11, 12 generates n-best output patterns which are fed into the output combination 14.

The output of the first or unmodified pattern matcher 11 combined with the output of the second pattern matcher 12 can be demonstrated to deliver superior performance over the unmodified pattern matcher alone. In this case, the signal modification is performed internally within the second pattern matcher 12 after the signal processor. The output combination module 14 receives as input both of the pattern matchers and combines them into a single output 15.

FIG. 6 shows a pattern recognition system which receives an input signal 1, and includes a pattern matcher 12 and a signal modifier 13. The pattern matcher 12 includes a signal processor 19 and a pattern matching algorithm 20, and generates an output 22 which best matches the input signal. The input signal is applied to the signal modifier 13. The modified signal from the signal modifier 13 is passed to the pattern matcher 12.

The output of the signal modifier 13 is a signal of a similar nature to the original signal, but with modifications introduced by the signal modification stage. The output of the signal modifier 13 is then passed directly to the pattern matcher 12 for further processing.

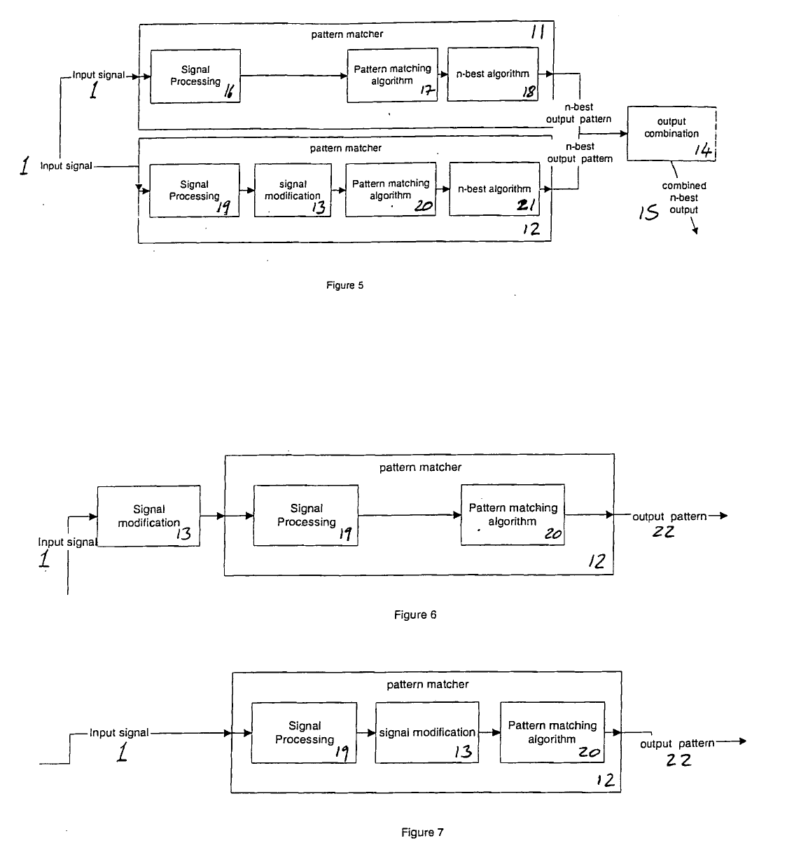

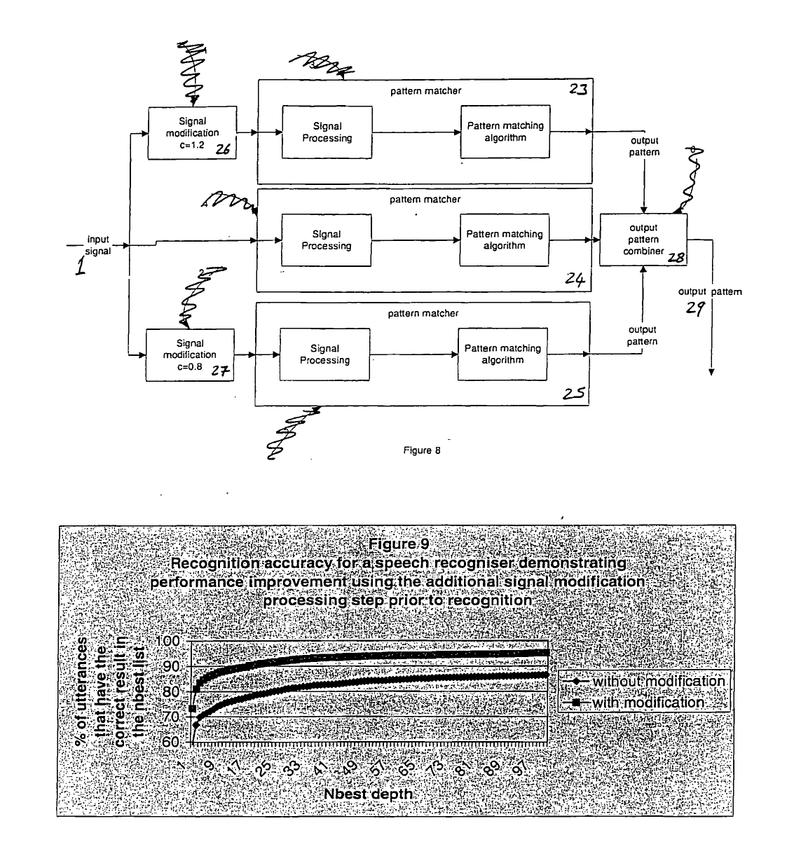

FIG. 7 shows another pattern recognition system in which the signal is modified within a pattern matcher 12. The system receives an input signal 1 to the pattern matcher 12. The pattern matcher 12 includes a signal processor 19, a signal modifier 13 and a pattern matching algorithm 20 and generates an output pattern 22 which best matches the input signal. The input signal 1 is processed through the signal processor and its output is presented to the signal modifier 13 for processing before the resulting processed material is sent on to the pattern matching algorithm 20 for further processing.

For the particular case of speech recognition and considering the embodiment shown in FIG. 6, where the signal is modified prior to being presented to the speech recogniser 12 (in the case of speech recognition, the pattern matcher 12 is known as the speech recogniser), the following is an example of a signal processing operation:

### EXAMPLE

The input signal is a continuous stream of speech samples x(t), where t is time. The signal is modified through the use of an expansion algorithm
y(t)=g*x(t)^{c}
where c is an expansion coefficient, g is a gain coefficient to rescale the signal back to acceptable levels and y(t) is the output, expanded, speech stream. Typically we would expect c to be within the range 0.6≦c≦1.4 and g to be around 20 for c=0.6 and g=0.1 for c=1.4.
Experiment 1:

FIG. 8 shows a system with external signal modification. In the system, there are 3 separate instances of pattern matchers, 23, 24 and 25. The first pattern matcher 23 receives the input signal after it has been processed through a first signal modification module 26. The second pattern matcher 24 receives the input signal 1 unchanged. The third pattern matcher 25 receives the input signal after it has been processed through a second signal modification module 27.

The signal modification function for the first signal modification module 26 is
y(t)=0.6*x(t)^{1.2}
the signal modification function for the second signal modification module 27 is
y(t)=2*x(t)^{0.8}

An output pattern combiner 28, receives its input as the 3 n-best sentence lists from pattern matchers 23, 24 and 25 and combines them all into a single list by selecting the top hypothesis from the first pattern matcher 23 first, then the top hypothesis from the second pattern matcher 24, and then the top hypothesis from the third pattern matcher 25. It then processes the remainder of the n-best hypotheses from each of the pattern matchers 23, 24 and 25 in a similar fashion. When the combination of outputs is complete, these output patterns 29 are presented to be further processed by other parts of the system which select the most appropriate matching pattern. Since pattern matching has taken place on three different versions of the input data, one unmodified and two modified in different ways, it is more likely that every utterance will be correctly recognised.

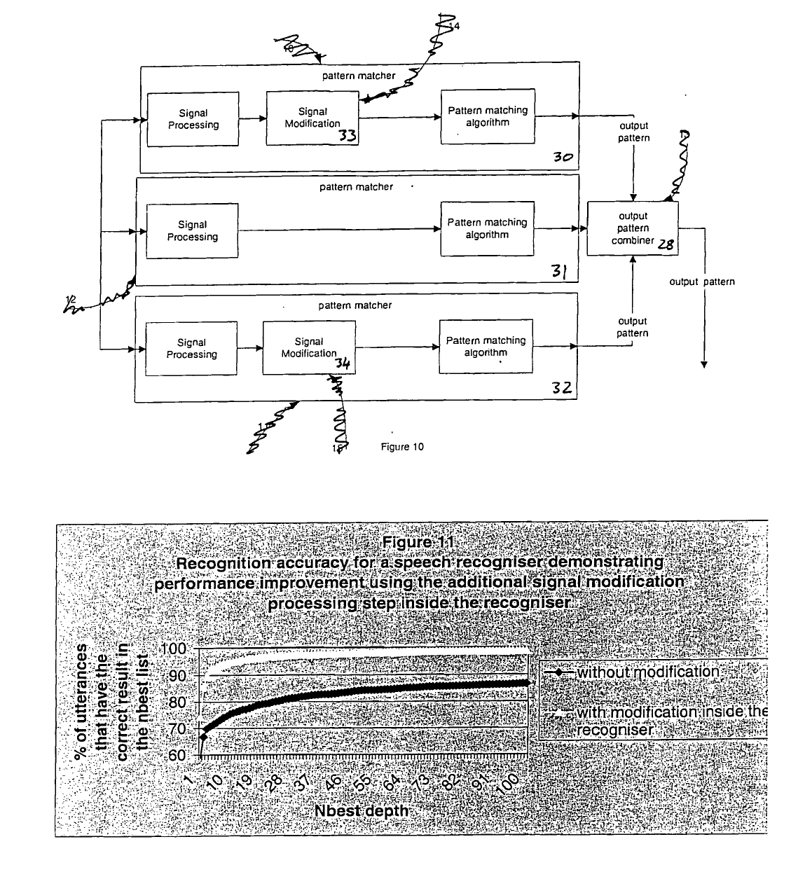

FIG. 9 is a graph showing the recognition accuracy for the speech recogniser shown in FIG. 8 when compared with a system which does not use modification. The difference in performance between the systems can be seen. The graph shows the recognition accuracy increasing as more and more n-best hypotheses are included in the output pattern list. It also shows that the modification technique significantly increases the accuracy of the system.

Experiment 2:

FIG. 10 shows a system with internal signal modification. There are three separate pattern matching modules, 30, 31 and 32. The second pattern matching module 31 does not contain any extra signal modification stage, while first and second modules 30 and 32 contain first and second signal modification modules 33 and 34 respectively. An output pattern combiner 28 is exactly the same module as module 28 in FIG. 8.

For the case where time signal modification is introduced within the recogniser, the signal modification module needs to process the output of the signal processing stage.

Typically the signal processing stage will produce a vector of numbers at regular intervals in time

Let this vector be V(t), where t is time.

Typical signal modification that could be performed on this vector would be addition, scaling, compression or expansion. For example, the vector could be scaled as follows
V′(t)=k*V(t)
where k could be a number within the range 0.6≦k≦1.4
for this particular example in FIG. 10, signal modification 34 has k=1.2 and signal modification 33 has k=0.8.

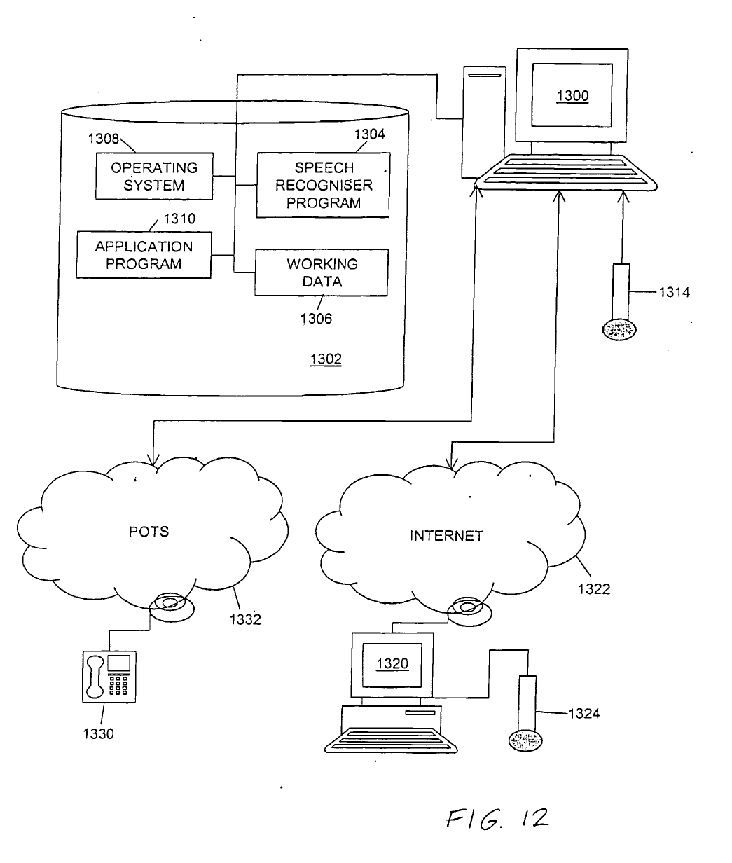

FIG. 11 is a graph showing the recognition accuracy for the speech recogniser shown in FIG. 10 and of a speech recogniser which doesn't use signal modification. The difference in performance between the systems can be seen. The graph shows the recognition accuracy increasing as more and more n-best hypotheses are included in the output pattern list. It also shows that the modification technique significantly increases the accuracy of the system.

### FURTHER EXAMPLES

Examples of other modifications are as follows:
Y(t)=g*x(t)

This is a linear modification. Of course, it will be realized that what is linear in one domain is non-linear in another. Normally, pattern recognition involved conversion between domains.

The following modification adds background noise:
Y(t)=x(t)+n(t)

Where n(t) is a background noise signal. Low levels of background noise sometimes improve recognition accuracy.

Also:

V′sub i(t)=V sub i(t)ˆc for expansion, where I is the index into the vector.

1. A pattern recogniser arranged to receive an input signal and to generate a matching output pattern comprising:
a pattern matcher including a signal processor and a pattern matching module;
a signal modification module which modifies the input signal before it reaches the pattern matching module; and
an output pattern combiner arranged to combine a plurality of output patterns matched by the pattern matching module with different modifications applied to the input signal.

2. A pattern recogniser according to claim 1 wherein the signal modification module is positioned ahead of the pattern matcher so that the signal processor and the pattern matching module act on modified material.

3. A pattern recogniser according to claim 2 further comprising, in parallel with the pattern matcher and signal modification module, one or more additional lines, each line including at least one further pattern matcher.

4. A pattern recogniser according to claim 3, wherein the output combination module generates a combined n-best output of patterns which best match the input signal.

5. A pattern recogniser according to claim 2, wherein the additional lines include a signal modification module positioned ahead of the pattern matcher.

6. A pattern recogniser according to claim 5, wherein the output combination module generates a combined n-best output of patterns which best match the input signal.

7. A pattern recogniser according to claim 1, wherein the signal modification module is positioned within the pattern matcher and between the output of the signal processor and the input to the pattern matching module.

8. A pattern recogniser according to claim 7 further comprising, in parallel with the pattern matcher and signal modification module, one or more additional lines, each line including at least one further pattern matcher.

9. A pattern recogniser according to claim 8, wherein the output combination module generates a combined n-best output which best matches the input signal.

10. A pattern recogniser according to claim 8, wherein the additional lines include a signal modification module positioned within the pattern matcher.

11. A pattern recogniser according to claim 10, wherein the output combination module generates a combined n-best output which best matches the input signal.

12. A pattern recogniser according to claim 1, wherein the or each pattern matcher includes an n-best pattern module which generates n output patterns.

13. A pattern recogniser according to claim 1, wherein the signal modification module is arranged to modify the input signal by applying an expansion function to it.

14. A pattern recogniser according to claim 13, wherein the expansion function applied to the input signal is:
y(t)=g*x(t)^{c}
where c is an expansion coefficient, g is a gain coefficient and y(t) is the output of the signal modification module.

15. A pattern recogniser according to claim 14, wherein c is in the range 0.6 to 1.4.

16. A pattern recogniser according to claim 14, wherein g is in the range of 0.1 to 20.

17. A pattern recogniser according to claim 1, wherein the signal modification is:
Y(t)=g*x(t)
where g is a gain coefficient and y(t) is the output of the signal modification module.

18. A pattern recogniser according to claim 1, wherein the signal modification is:
Y(t)=x(t)+n(t)
where n(t) is a background noise signal.

19. A pattern recogniser according to claim 1, wherein the signal modification is:
V′sub i(t)=V sub i(t)ˆc for expansion, where I is the index into the vector.

20. A speech recognition system comprising the pattern recogniser according to claim 1.

21. A method of pattern matching an input signal to generate a matching output pattern comprising:
i) modifying the input signal
ii) pattern matching the modified signal and either an unmodified input signal or a differently modified signal; and
iii) combining the output patterns.

22. A method according to claim 21, wherein the pattern matching takes place within a pattern matcher including a signal processor and a pattern matching module, and signal modification takes place before reaching the pattern matcher so that the signal processor and the pattern matching module act on modified material.

23. A method according to claim 22, further comprising, in parallel to the pattern matching operation, one or more further pattern matching operations.

24. A method according to claim 23, further comprising generating a combined n-best output which best matches the input signal.

25. A method according to claim 23, wherein the additional pattern matching operations include signal modification ahead of the pattern matcher.

26. A method according to claim 25, further comprising generating a combined n-best output which best matches the input signal.

27. A method according to claim 21, wherein the pattern matching takes place within a pattern matcher including a signal processor and a pattern matching module, and signal modification takes place within the pattern matcher and between the output of the signal processor and the input to the pattern matching module so that the pattern matching module acts on modified material.

28. A method according to claim 27, further comprising, in parallel to the pattern matching operation, one or more further pattern matching operations.

29. A method according to claim 28, further comprising generating a combined n-best output which best matches the input signal.

30. A method according to claim 28, wherein the additional pattern matching operations include signal modification within the pattern matcher.

31. A method according to claim 30, further comprising generating a combined n-best output which best matches the input signal.

32. A method according to claim 21, wherein modification of the input signal is by the application of an expansion function.

33. A method according to claim 32, wherein the expansion function applied to the input signal is:
y(t)=g*x(t)^{c}
where c is an expansion coefficient, g is a gain coefficient and y(t) is the output of the signal modification module.

34. A method according to claim 33, wherein c is in the range 0.6 to 1.4.

35. A method according to claim 33, wherein g is in the range of 0.1 to 20.

36. A method according to claim 21, wherein the signal modification is:
Y(t)=g*x(t)
where g is a gain coefficient and y(t) is the output of the signal modification module.

37. A method according to claim 21, wherein the signal modification is:
Y(t)=x(t)+n(t)
where n(t) is a background noise signal.

38. A method according to claim 21, wherein the signal modification is:
V′sub i(t)=V sub i(t)ˆc for expansion, where I is the index into the vector.
